(19) United States
(12) Patent Application Publication
(10) Pub. No.: US 2015/0305986 A1
(43) Pub. Date: Oct. 29, 2015

(54) Feeding Tube Protective Cover Device

(71) Applicant: Curtis R. Snyder, New Port, PA (US)

(72) Inventors: Curtis R. Snyder, New Port, PA (US); Beverly Snyder, New Port, PA (US)

(21) Appl. No.: 14/259,766

(22) Filed: Apr. 23, 2014

(51) Int. Cl. A61J 15/00

(52) U.S. Cl. CPC A61J 15/0061

(57) ABSTRACT

A feeding tube protective cover device covers and protects a feeding tube to allow a person to maintain an active lifestyle while having a feeding tube in place. The device includes a port extending through an abdomen to be in fluid communication with a stomach within the abdomen. A tube is coupled to the port and extends away from the abdomen. A perimeter wall defines a cage positionable around the port abutting the abdomen. A slot extends into the perimeter wall extending inwardly towards the open interior face from a distal edge of the perimeter wall relative to the open interior face.

The tube is selectively positionable in the slot to be engaged to the perimeter wall. A band is wrapped around the abdomen over the cage such that the band secures the cage against the abdomen.

### BACKGROUND OF THE DISCLOSURE

### Field of the Disclosure

The disclosure relates to protective cover devices and more particularly pertains to a new protective cover device for covering and protecting a feeding tube to allow a person to maintain an active lifestyle while having a feeding tube in place.

### SUMMARY OF THE DISCLOSURE

An embodiment of the disclosure meets the needs presented above by generally comprising a port extending through an abdomen to be in fluid communication with a stomach within the abdomen. A tube is coupled to the port and extends away from the abdomen. A perimeter wall defines a cage positionable around the port abutting the abdomen. A slot extends into the perimeter wall extending inwardly towards the open interior face from a distal edge of the perimeter wall relative to the open interior face. The tube is selectively positionable in the slot to be engaged to the perimeter wall. A band is wrapped around the abdomen over the cage such that the band secures the cage against the abdomen.

There has thus been outlined, rather broadly, the more important features of the disclosure in order that the detailed description thereof that follows may be better understood, and in order that the present contribution to the art may be better appreciated.

There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side perspective view of a feeding tube protective cover device according to an embodiment of the disclosure.

FIG. 2 is a side view of a cage of an embodiment of the disclosure.

FIG. 3 is a front view of an embodiment of the disclosure.

FIG. 4 is a front view of an embodiment of the disclosure in use.

FIG. 5 is a cross-sectional view of an embodiment of the disclosure taken along line 5-5 of FIG. 4.

### DESCRIPTION OF THE PREFERRED EMBODIMENT

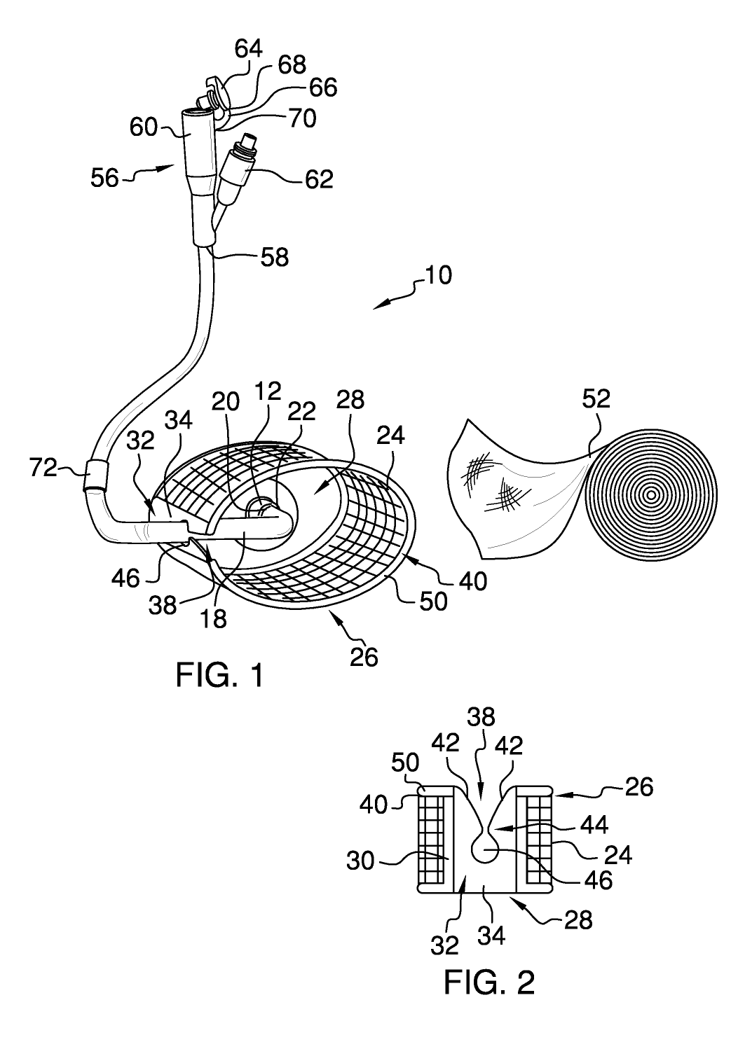

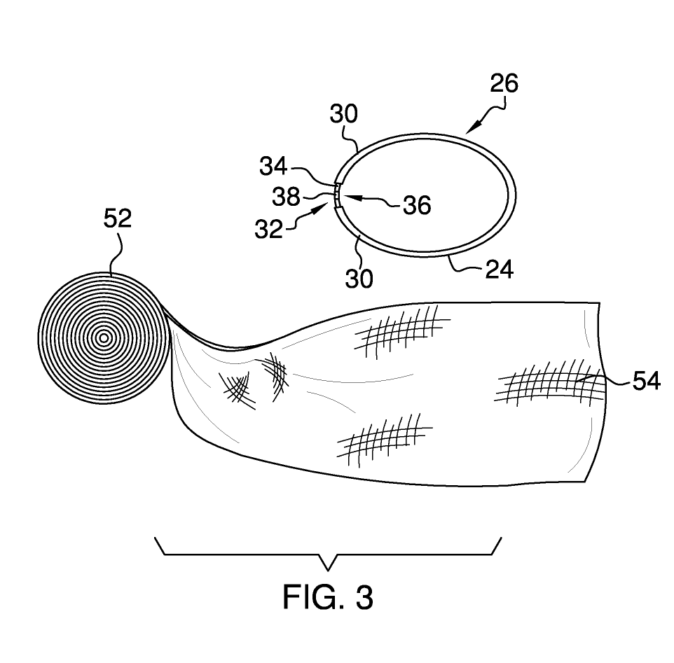

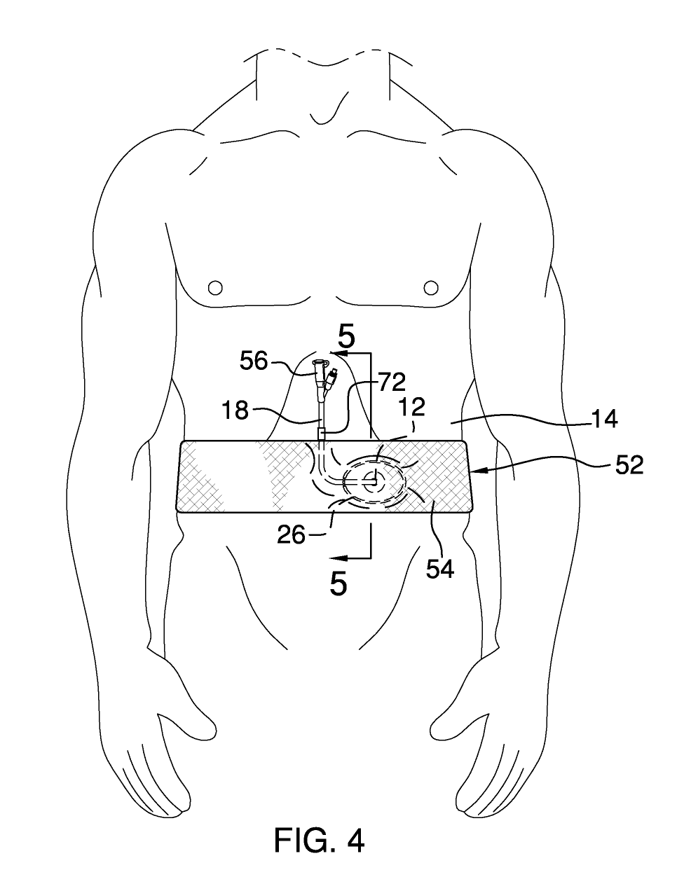

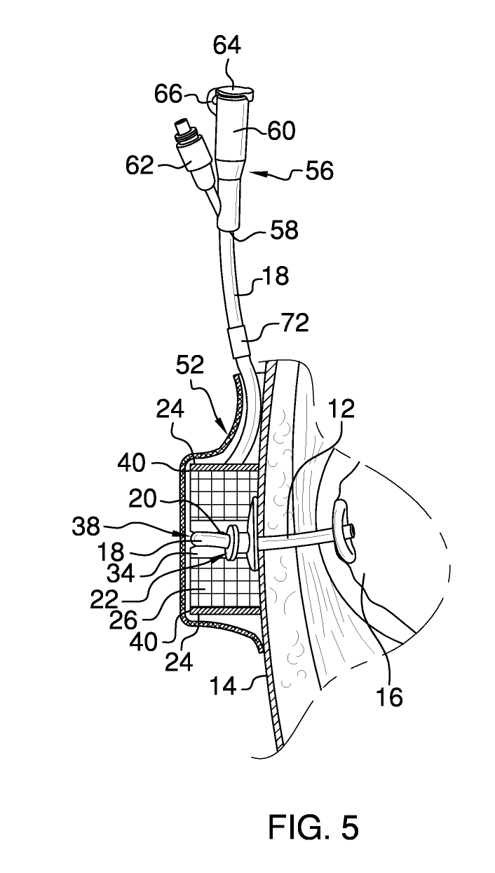

With reference now to the drawings, and in particular to FIGS. 1 through 5 thereof, a new protective cover device embodying the principles and concepts of an embodiment of the disclosure and generally designated by the reference numeral 10 will be described.

As best illustrated in FIGS. 1 through 5, the feeding tube protective cover device 10 generally comprises a port 12 configured for coupling to an abdomen 14 of a person such that the port 12 extends through the abdomen 14 to be in fluid communication with a stomach 16 within the abdomen 14. The port 12 may utilize conventional form for the purpose of introducing food, medications, or the like into the stomach 16 through the port 12. A tube 18 has a first end 20 coupled to an exterior side 22 of the port 12 such that the tube 18 is configured to extend away from the abdomen 14.

A perimeter wall 24 defines a cage 26 positionable around the port 12. The perimeter wall 24 defines an open interior face 28 configured for abutting the abdomen 14 around the port 12. The perimeter wall 24 comprises a casing 30 having an open section 32. The perimeter wall 24 further comprises a panel 34 positioned in the open section 32 of the casing 30. The panel 34 may comprise a resiliently compressible material such as foam, rubber, or the like. The perimeter wall 24 is elliptical and the panel 34 may be positioned at a longitudinal end 36 of the perimeter wall 24. A slot 38 extends into the perimeter wall 24. More specifically, the slot 38 extends into the panel 34 in the open section 32 of the casing 30 such that the slot 38 is deformable to facilitate positioning of the tube 18 in the slot 38. The slot 38 extends inwardly towards the open interior face 28 from the distal edge 40 of the perimeter wall 24 relative to the open interior face 28. The tube 18 is selectively positionable in the slot 38 wherein the tube 18 is engaged to the perimeter wall 24. The slot 38 is defined by a pair of opposed edges 42. The opposed edges 42 taper into the slot 38 extending inwardly from the distal edge 40 of the perimeter wall 24 defining a neck 44 in the slot 38. The opposed edges 42 may be arcuate and join to form a bulbous portion 46 of the slot 38 extending inwardly into the perimeter wall from the neck 44. The tube 18 is selectively positionable in the bulbous portion 46 wherein the tube 18 is retained in the slot 38.

A liner 50 may be coupled to and extend around the distal edge 40 of the perimeter wall 24. The liner 50 is coextensive with the casing 30. A band 52 is elongated and configured for being wrapped around the abdomen 14 over the cage 26 such that the band 52 secures the cage 30 against the abdomen 14. The band 52 may be constructed of a resiliently flexible netting 54 similar to a compression bandage or the like.

A connector 56 is coupled to a second end 58 of the tube 18. The connector 56 has a feeding aperture 60 and a flushing aperture 62. Each of the feeding aperture 60 and the flushing aperture 62 are in fluid communication with the tube 18. A cap 64 is selectively couplable to the feeding aperture 60 wherein the feeding aperture 60 is closed when the cap 64 is coupled to the connector 56. A tether 66 has a first end 68 coupled to the connector 56 and a second end 70 coupled to the cap 64 wherein the tether 66 couples the cap 64 to the connector 56. The flushing aperture 62 may incorporate a conventional valve or the like to seal the flushing aperture 62 when it is not being used. A clamp 72 of conventional design may be coupled to the tube 18. The clamp 72 selectively pinches the tube 18 wherein fluid communication is restricted through the tube 18 by the clamp 72.

In use, the cage 26 is positioned around the port 12 providing desired protection and space around the port 12. The tube 18 is positioned to extend through the slot 38 gently holding the tube 18 in a desired position reducing stress on the abdomen 14 at the site of the port 12. The band 52 is wrapped around the abdomen to secure the cage 26 and tube 18 sufficiently static relative to the abdomen and port that the person may move freely and participate in daily or even strenuous activities.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure.

I claim:

1. A feeding tube protective cover device comprising:
a port configured for coupling to an abdomen of a person such that said port extends through the abdomen to be in fluid communication with a stomach within the abdomen;
a tube having a first end coupled to an exterior side of said port such that said tube is configured to extend away from the abdomen;
a perimeter wall defining a cage positionable around said port, said perimeter wall defining an open interior face configured for abutting the abdomen around said port;
a slot extending into said perimeter wall, said slot extending inwardly towards said open interior face from said distal edge of said perimeter wall relative to said open interior face, said tube being selectively positionable in said slot wherein said tube is engaged to said perimeter wall; and
a band, said band being elongated wherein said band is configured for being wrapped around the abdomen over said cage such that said band secures said cage against the abdomen.

2. The device of claim 1, further comprising said band comprising resiliently flexible netting.

3. The device of claim 1, further comprising said slot being defined by a pair of opposed edges, said opposed edges tapering into said slot extending inwardly from said distal edge of said perimeter wall defining a neck in said slot, said opposed edges being arcuate and joining to form a bulbous portion of said slot extending inwardly from said neck, said tube being selectively positionable in said bulbous portion wherein said tube is retained in said slot.

4. The device of claim 1, further comprising said perimeter wall comprising a casing having an open section, said perimeter wall further comprising a panel positioned in said open section of said casing, said slot extending into said panel in said open section of said casing.

5. The device of claim 4, further comprising said panel comprising a resiliently compressible material.

6. The device of claim 4, further comprising said perimeter wall being elliptical.

7. The device of claim 6, further comprising said panel being positioned at a longitudinal end of said perimeter wall.

8. The device of claim 1, further comprising a clamp coupled to said tube, said clamp selectively pinching said tube wherein fluid communication is restricted through said tube.

9. The device of claim 1, further comprising a connector coupled to a second end of said tube, said connector having a feeding aperture and a flushing aperture, each of said feeding aperture and said flushing aperture being in fluid communication with said tube.

10. The device of claim 9, further comprising a cap, said cap being selectively couplable to said feeding aperture wherein said feeding aperture is closed when said cap is coupled to said connector.

11. The device of claim 10, further comprising a tether having a first end coupled to said connector and a second end coupled to said cap wherein said tether couples said cap to said connector.

12. The device of claim 4, further comprising a liner coupled to and extending around said distal edge of said perimeter wall, said liner being coextensive with said casing.

13. A feeding tube protective cover device comprising:
a port configured for coupling to an abdomen of a person such that said port extends through the abdomen to be in fluid communication with a stomach within the abdomen;
a tube having a first end coupled to an exterior side of said port such that said tube is configured to extend away from the abdomen;
a perimeter wall defining a cage positionable around said port, said perimeter wall defining an open interior face configured for abutting the abdomen around said port, said perimeter wall comprising a casing having an open section, said perimeter wall further comprising a panel positioned in said open section of said casing, said panel comprising a resiliently compressible material, said perimeter wall being elliptical, said panel being positioned at a longitudinal end of said perimeter wall;
a slot extending into said perimeter wall, said slot extending into said panel in said open section of said casing, said slot extending inwardly towards said open interior face from said distal edge of said perimeter wall relative to said open interior face, said tube being selectively positionable in said slot wherein said tube is engaged to said perimeter wall, said slot being defined by a pair of opposed edges, said opposed edges tapering into said slot extending inwardly from said distal edge of said perimeter wall defining a neck in said slot, said opposed edges being arcuate and joining to form a bulbous portion of said slot extending inwardly from said neck, said tube being selectively positionable in said bulbous portion wherein said tube is retained in said slot;
a liner coupled to and extending around said distal edge of said perimeter wall, said liner being coextensive with said casing;
a band, said band being elongated wherein said band is configured for being wrapped around the abdomen over said cage such that said band secures said cage against the abdomen, said band comprising resiliently flexible netting;
a clamp coupled to said tube, said clamp selectively pinching said tube wherein fluid communication is restricted through said tube;
a connector coupled to a second end of said tube, said connector having a feeding aperture and a flushing aperture, each of said feeding aperture and said flushing aperture being in fluid communication with said tube;
a cap, said cap being selectively couplable to said feeding aperture wherein said feeding aperture is closed when said cap is coupled to said connector; and
a tether having a first end coupled to said connector and a second end coupled to said cap wherein said tether couples said cap to said connector.
